(19) United States
(12) Patent Application Publication
(10) Pub. No.: US 2026/0166737 A1
(43) Pub. Date: Jun. 18, 2026

(54) METHOD AND SYSTEM FOR ZERO-SHOT SHAPE RECONSTRUCTION ENABLED ROBOTIC GRASPING

(71) Applicants: Toyota Research Institute, Inc., Los Altos, CA (US); Carnegie Mellon University, Pittsburgh, PA (US)

(72) Inventors: Sergey Zakharov, San Francisco, CA (US); Katherine Liu, Mountain View, CA (US); Vitor Guizilini, Santa Clara, CA (US); Rares A. Ambrus, San Francisco, CA (US); Shun Iwase, Pittsburgh, PA (US); Kris Kitani, Pittsburgh, PA (US)

(73) Assignees: Toyota Research Institute, Inc., Los Altos, CA (US); Toyota Jidosha Kabushiki Kaisha, Toyota-shi Aichi-ken (JP); Carnegie Mellon University, Pittsburgh, PA (US)

(21) Appl. No.: 19/225,581

(22) Filed: Jun. 2, 2025

Related U.S. Application Data
(60) Provisional application No. 63/733,029, filed on Dec. 12, 2024.

(51) Int. Cl. B25J 9/16; G06T 7/55; G06T 7/73; G06V 10/26; G06V 10/774; G06V 20/50

(52) U.S. Cl. CPC B25J 9/1666; B25J 9/163; B25J 9/1697; G06T 7/55; G06T 7/73; G06V 10/26; G06V 10/774; G06V 20/50; G06T 2207/20081

(57) ABSTRACT

A method comprises receiving training data comprising a plurality of images containing one or more objects, a plurality of depth maps associated with the plurality of images, and ground truth data associated with the plurality of images, the ground truth data comprising shapes and grasp poses associated with the one or more objects in the plurality of images, and training a machine learning model, using the training data, to receive a first image containing one or more first objects and a first depth map associated with the first image, and output first shapes of the one or more first objects and first grasp poses for the one or more first objects. The machine learning model comprises a conditional variational autoencoder, a multi-object encoder to encode multi-object reasoning associated with an object, and 3D occlusion fields determined by ray casting.

### CROSS-REFERENCE TO RELATED APPLICATION

The present specification is based on, and claims the benefit of, U.S. Provisional Application No. 63/733,029, filed Dec. 12, 2024, the disclosure of which is hereby incorporated by reference in its entirety.

### TECHNICAL FIELD

The present specification relates to robotic grasping, and more particularly to a method and system for zero-shot shape reconstruction enabled robotic grasping.

### BACKGROUND

In order for a robot to grasp objects in a scene, the robot may determine grasp poses for the objects indicating how each object should be grasped. Robust robotic grasping may require accurate geometric understanding of target objects, as well as their surroundings. However, without explicitly modeling the geometry of the target objects, unexpected collisions and unstable contact with target objects may occur. Furthermore, using multi-view images to reconstruct the target objects in advance may introduce additional computational overhead and may require a more complex setup. In addition, multi-view reconstruction may be impractical for objects placed within confined spaces, such as shelves or boxes. Further still, the lack of large-scale datasets with ground-truth 3D shapes and grasp poses annotations further complicates accurate 3D reconstruction from a single RGB-D image. In some instances, sparse voxel representations may outperform volumetric and NeRF-like implicit shape representations in terms of runtime, accuracy, and resolution, particularly for regression-based zero-shot 3D reconstruction. As such, there is a need for an improved method and system for zero-shot shape reconstruction enabled robotic grasping.

### SUMMARY

In one embodiment, a method may include receiving training data comprising a plurality of images containing one or more objects, a plurality of depth maps associated with the plurality of images, and ground truth data associated with the plurality of images. The ground truth data may comprise shapes and grasp poses associated with the one or more objects in the plurality of images. The method may further comprise training a machine learning model, using the training data, to receive a first image containing one or more first objects and a first depth map associated with the first image, and output first shapes of the one or more first objects and first grasp poses for the one or more first objects. The machine learning model may comprise a conditional variational autoencoder, a multi-object encoder to encode multi-object reasoning associated with an object, and 3D occlusion fields determined by ray casting.

In another embodiment, a computing device may comprise one or more processors configured to receive training data comprising a plurality of images containing one or more objects, a plurality of depth maps associated with the plurality of images, and ground truth data associated with the plurality of images. The ground truth data may comprise shapes and grasp poses associated with the objects in the plurality of images. The one or more processors may be further configured to train a machine learning model, using the training data, to receive a first image containing one or more first objects and a first depth map associated with the first image, and output first shapes of the one or more first objects and first grasp poses for the one or more first objects. The machine learning model may comprise a conditional variational autoencoder, a multi-object encoder to encode multi-object reasoning associated with an object, and 3D occlusion fields determined by ray casting.

In another embodiment, a non-transitory computer readable storage medium may comprise a memory storing a program that, when executed by a processor, causes the processor to receive training data comprising a plurality of images containing one or more objects, a plurality of depth maps associated with the plurality of images, and ground truth data associated with the plurality of images. The ground truth data may comprise shapes and grasp poses associated with the objects in the plurality of images. The program may further cause the processor to train a machine learning model, using the training data, to receive a first image containing one or more first objects and a first depth map associated with the first image, and output first shapes of the one or more first objects and grasp poses for the one or more first objects. The machine learning model may comprise a conditional variational autoencoder, a multi-object encoder to encode multi-object reasoning associated with an object, and 3D occlusion fields determined by ray casting.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1 schematically depicts an architecture of a machine learning model for zero-shot shape reconstruction enabled robotic grasping, according to one or more embodiments shown and described herein;

FIG. 2 depicts a schematic diagram of a computing device for implementing the machine learning model of FIG. 1, according to one or more embodiments shown and described herein;

FIG. 3 illustrates an example instance mask and occlusion fields, according to one or more embodiments shown and described herein;

FIG. 4 depicts an example grasp pose refinement, according to one or more embodiments shown and described herein;

FIG. 5 depicts a flowchart of an example method of operating the computing device of FIG. 2 to train the machine learning model, according to one or more embodiments shown and described herein; and

FIG. 6 depicts a flowchart of an example method of operating the computing device of FIG. 2 after the machine learning model has been trained, according to one or more embodiments shown and described herein.

### DETAILED DESCRIPTION

The embodiments disclosed herein provide a novel framework for near real-time 3D reconstruction and 6D grasp pose prediction. Embodiments disclosed herein enhance grasp pose prediction by leveraging physics-based contact constraints and collision detection. Since robotic environments often involve multiple objects with inter-object occlusions and close contacts, embodiments disclosed herein include a multi-object encoder and 3D occlusion fields. These components effectively model inter-object relationships and occlusions, thereby improving reconstruction quality. In addition, embodiments disclosed herein utilize a refinement algorithm to improve grasp poses using the predicted reconstruction. Reconstructions generated by the embodiments disclosed herein provide reliable contact points and collision masks between a gripper (e.g., a robotic arm) and a target object, which may be used to refine the grasp poses.

In embodiments disclosed herein, a machine learning model may be trained to receive an input image and a depth map associated with the image. The image may include one or more objects. The machine learning model may be trained to output grasp poses for the objects in the image. In particular, the machine learning model may be trained to simultaneously perform a 3D reconstruction of the scene captured by the image and predict grasp poses for the objects in the image. As such, after the machine learning model is trained, it may be used by a robotic arm or other gripper to grasp real-world objects. For example, a robotic arm may capture an image and depth map of a scene containing one or more objects. The image may be input into the trained machine learning model, which may output grasp poses for the objects. The robotic arm may then grasp and manipulate one or more of the objects based on the output grasp poses.

Known methods of grasp pose prediction often assume prior knowledge of 3D objects and rely on simplified analytical models based on force closure principles. However, embodiments disclosed herein allow for zero-shot robotic grasping, which refers to the ability to grasp unseen target objects without prior knowledge. In particular, embodiments disclosed herein describe an efficient and generalizable model for simultaneous 3D shape reconstruction and grasp pose prediction from a single RGB-D observation. The predicted reconstructions can be used to refine grasp poses via contact-based constraints and collision detection.

In embodiments, an octree is used as a shape representation where attributes such as image features, the signed distance function (SDF), normal vectors on object surfaces (referred to herein as normal), and grasp poses are defined at the deepest level of the octree. In one example, an input octree may be represented as a tuple of voxel centers p at the final depth, associated with the image features f,

$$x = ( p , f ) , p ∈ {ℝ}^{N \times 3} , f ∈ {ℝ}^{N \times D} , \qquad ( 1 )$$

where N is the number of voxels. Unlike point clouds, an octree structure enables efficient depth-first search and recursive subdivision to octants, making it ideal for high-resolution shape reconstruction and dense grasp pose prediction in a memory and computationally efficient manner.

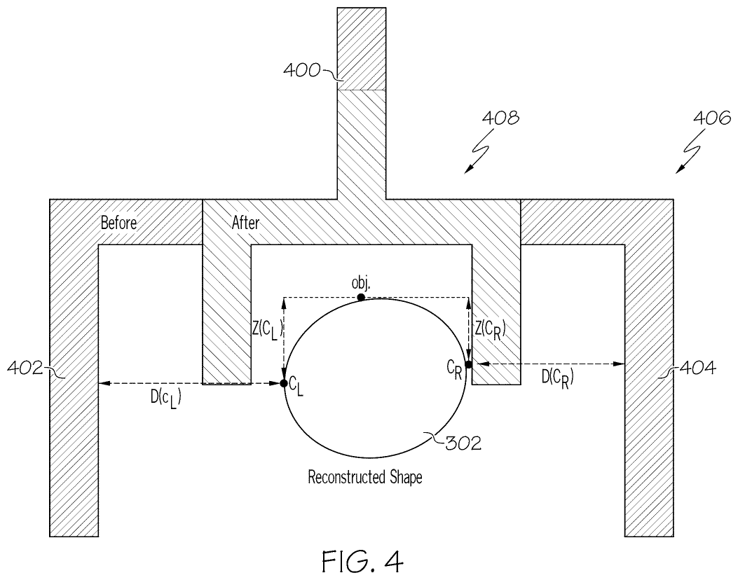

In embodiments, grasp poses may be represented using a general two-finger parallel gripper model. An example two-finger parallel gripper 400 is shown in FIG. 4 having fingers 402 and 404. In embodiments, grasp poses may comprise the following components: graspness vϵ [symbol] ^{M}, which indicates the robustness of grasp positions, quality qϵ [symbol] ^{M}, which may be computed using the force closure algorithm, approach vectors aϵ [symbol] ^{M×3}, tangential vectors tϵ [symbol] ^{M×3}, width wϵ [symbol] ^{M} and depth dϵ [symbol] ^{M}:

$$g = [ v q a t w d ] , \qquad ( 2 )$$

where M denotes the number of voxels in the target octree, and the closest grasp pose within a 5 mm radius is assigned to each point. If it does not exist, its corresponding graspness is set to 0. In embodiments, a Gram-Schmidt orthogonalization may be used to recover rotation matrices from approach and tangential vectors. The rotation matrices may be defined in a gripper coordinate system. With the grasp poses g, the target octree may be defined as

$$y = ( {p}^{gt} , {f}^{gt} ) = ( {p}^{gt} , [ s n g ] ) , \qquad ( 3 )$$

wherein sϵ [symbol] ^{M} is the SDF, and nϵ [symbol] ^{M×3} is the normal vectors of the target octree.

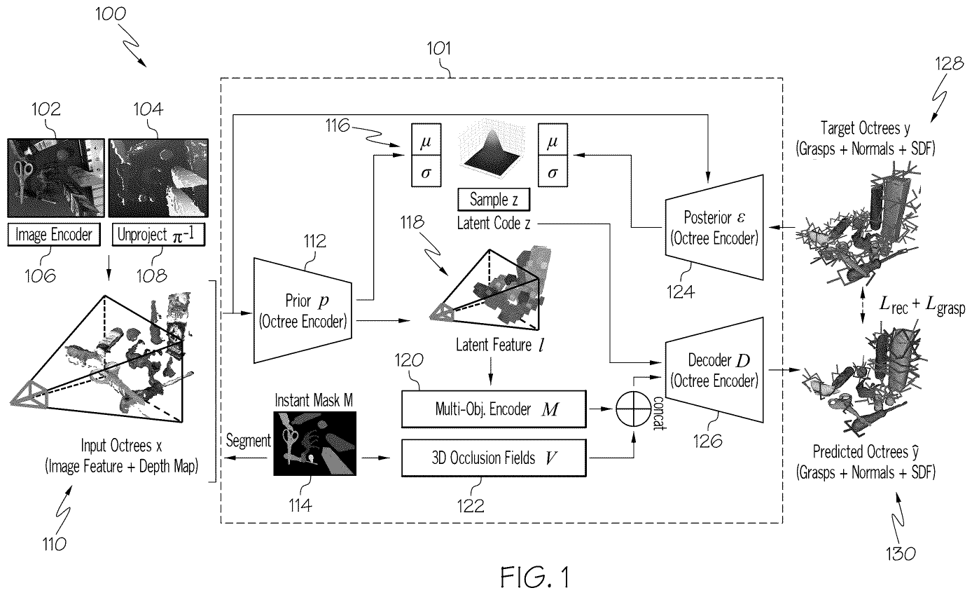

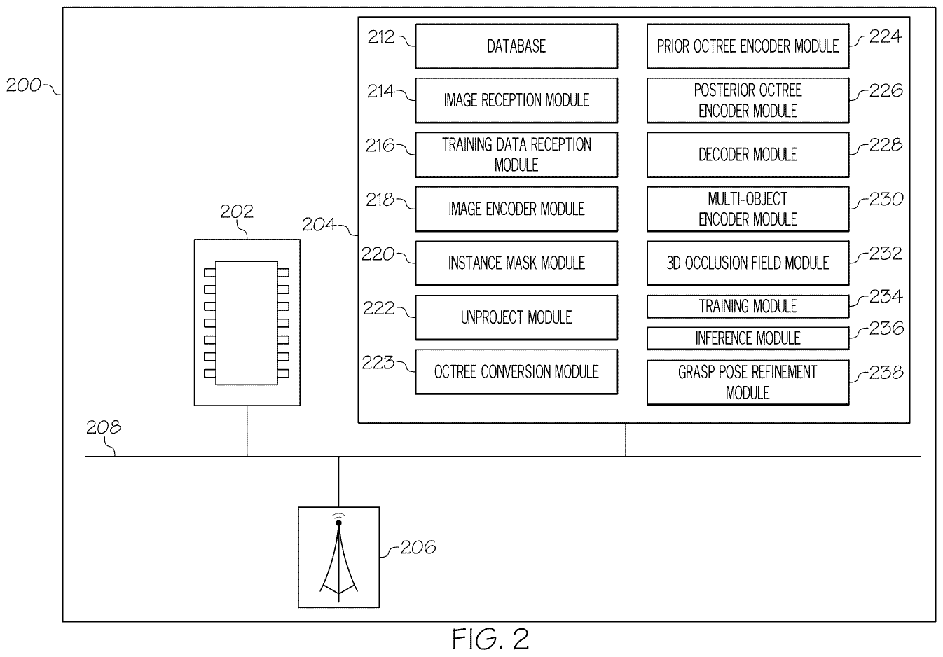

Turning now to the figures, FIG. 1 illustrates an example architecture of a machine learning model 100, as disclosed herein. The machine learning model 100 may be trained to receive an input RGB-D image and output predicted grasp poses for objects in the image, as described above. In particular, given input octrees x, composed of per-instance partial point clouds derived from depth maps and instance masks, along with their corresponding image features, the machine learning model 100 predicts 3D reconstructions and grasp poses ŷ represented as octrees. The machine learning model 100 is built upon an octree-based U-Net and conditional variational autoencoder (CVAE) to model shape reconstruction uncertainty and grasp pose prediction, while maintaining near real-time inference, as disclosed herein. The components of the machine learning model 100 are discussed in further detail below in connection with FIG. 2.

FIG. 2 depicts a computing device 200 for performing zero-shot shape reconstruction enabled robotic grasping, as disclosed herein. In particular, the computing device 200 may be used to train the machine learning model 100 of FIG. 1 and to use the machine learning model 100 after it has been trained.

In the example of FIG. 2, the computing device 200 comprises one or more processors 202, one or more memory modules 204, network interface hardware 206, and a communication path 208. The one or more processors 202 may be a controller, an integrated circuit, a microchip, a computer, or any other computing device. The one or more memory modules 204 may comprise RAM, ROM, flash memories, hard drives, or any device capable of storing machine readable and executable instructions such that the machine readable and executable instructions can be accessed by the one or more processors 202.

The network interface hardware 206 can be communicatively coupled to the communication path 208 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 206 includes hardware configured to operate in accordance with the Bluetooth® wireless communication protocol. The network interface hardware 206 of the computing device 200 may receive images captured by one or more cameras, as disclosed in further detail below.

The one or more memory modules 204 include a database 212, an image reception module 214, a training data reception module 216, an image encoder module 218, an instance mask module 220, an unproject module 222, an octree conversion module 223, a prior octree encoder module 224, a posterior octree encoder module 226, a decoder module 228, a multi-object encoder module 230, a 3D occlusion field module 232, a training module 234, an inference module 236, and a grasp pose refinement module 238. Each of the database 212, the image reception module 214, the training data reception module 216, the image encoder module 218, the instance mask module 220, the unproject module 222, the octree conversion module 223, the prior octree encoder module 224, the posterior octree encoder module 226, the decoder module 228, the multi-object encoder module 230, the 3D occlusion field module 232, the training module 234, the inference module 236, and the grasp pose refinement module 238 may be a program module in the form of operating systems, application program modules, and other program modules stored in the one or more memory modules 204. In some embodiments, the program module may be stored in a remote storage device that may communicate with the computing device 200. Such a program module may include, but is not limited to, routines, subroutines, programs, objects, components, data structures and the like for performing specific tasks or executing specific data types as will be described below.

The database 212 may store image data, depth map data, and training data used to train the machine learning model 100, as disclosed herein. The database 212 may also store the parameters of the machine learning model 100 as it is trained.

Referring still to FIG. 2, the image reception module 214 may receive an image and a depth map (e.g., an RGB-D image) of a scene containing one or more objects. The received image may be input into the machine learning model 100 after it is trained and the machine learning model 100 may output predicted grasp poses, as disclosed in further detail herein. The predicted grasp poses may be by a robotic arm or other gripper to grasp and manipulate the objects.

Referring still to FIG. 2, the training data reception module 216 may receive training data that may be used to train the machine learning model 100, as disclosed in further detail herein. In embodiments, the training data received by the training data reception module 216 may include a plurality of images, each containing one or more objects, depth maps associated with the images, and ground truth octree data associated with the images. The ground truth octree data may comprise grasp poses for each object in the images, normal for each object in the images, and a SDF for each object in the images, as shown as target octrees y 128 of FIG. 1.

Referring still to FIG. 2, the image encoder module 218 may encode images received by the image reception module 214 and/or the training data reception module 216 to generate features. In particular, an RGB image Iϵ [symbol] ^{H×W×3} may be encoded to extract an image feature W. As shown in FIG. 1, an example image 102 may be input to an image encoder 106 to encode the image 102 to generate image features. The image encoder 106 of FIG. 1 may be implemented by the image encoder module 218 of FIG. 2. The image features generated by the image encoder module 218 may be included in the input octree x that is input into the machine learning model 100, as shown in FIG. 1.

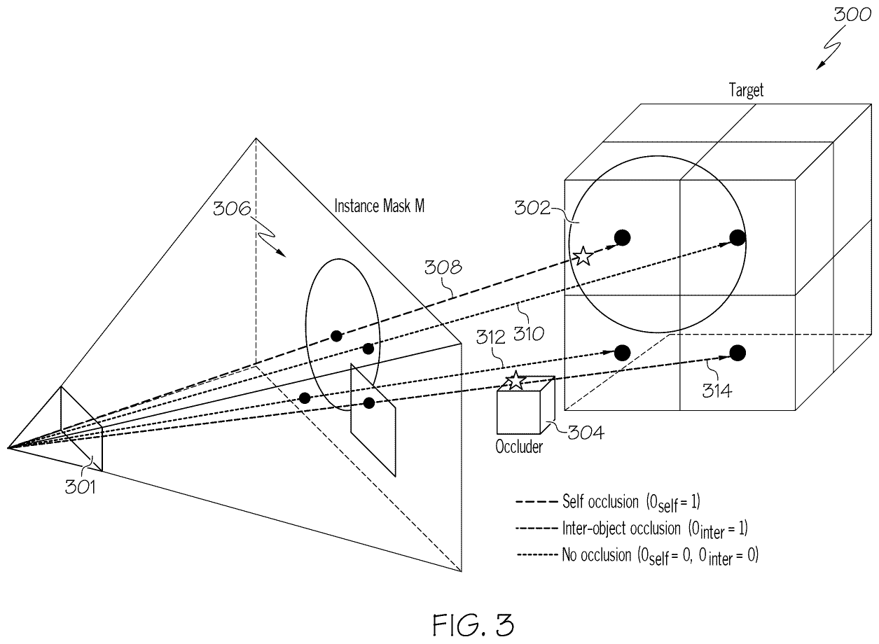

Referring back to FIG. 2, the instance mask module 220 may identify the objects in an image received by the image reception module 214 or the training data reception module 216, and may generate 2D instance masks for each identified object. In particular, the instance mask module 220 may generate 2D instance masks Mϵ [symbol] ^{H×W}. An instance mask Mᵢ may represent an i-th object mask. FIG. 3 shows a scene containing objects 302 and 304. In the example of FIG. 3, the object 304 occludes the object 302. FIG. 3 shows an example 2D instance mask 306 that may be generated by the instance mask module 220 for the scene 300. In particular, the instance mask 306 includes a 2D projection of the objects 302, 304. Referring back to FIG. 1, an Instance Mask M 114 is shown applied to the Input Octrees x 110 and the 3D occlusion fields V 122. The Instance Mask M 114 may be generated by the instance mask module 220 of FIG. 2.

Referring back to FIG. 2, the unproject module 222 may unproject the image features generated by the image encoder module 218 into 3D space for each object identified by the instance mask module 220. In particular, the unproject module 222 may unproject the image features into 3D space by (qᵢ, wᵢ)=π⁻¹(W, D, K, Mᵢ) where qᵢ and wᵢ denote a 3D point cloud and its corresponding features of an i-th object, respectively. Here, π is the unprojection function as shown as an unproject function 108 of FIG. 1, Dϵ [symbol] ^{H×W} is the depth map and Kϵ [symbol] ^{3×3} denotes camera intrinsics of the camera that captured the image. In the example of FIG. 1, an example depth map 104 is shown that corresponds to the example image 102.

Referring back to FIG. 2, the octree conversion module 223 may convert the 3D point cloud features generated by the unproject module 222 into an octree. In particular, the octree conversion module 223 may convert the 3D point cloud features to an octree xᵢ=(pᵢ, fᵢ)=G(qᵢ, wᵢ) where G is the conversion function from the point cloud and its features to an octree.

Referring back to FIG. 1, in order to improve the shape reconstruction quality, the machine learning model 100 utilizes probabilistic modeling through an octree-based conditional variational autoencoder (CVAE) 101 to address the inherent uncertainty in single-view shape reconstruction, which is crucial for improving both reconstruction and grasp pose prediction quality. In the example of FIG. 1, the octree-based CVAE 101 comprises a posterior encoder [symbol] 124, a prior encoder [symbol] 112, and a decoder [symbol] 126 to learn latent representations of 3D shapes and grasp poses together as diagonal Gaussian.

In embodiments, the encoder ε(zᵢ|xᵢ, yᵢ) may learn to predict the latent code zᵢ 116, as shown in FIG. 1, based on the predicted and ground-truth octrees xᵢ and yᵢ. The latent code zᵢ 116 may be projected to a lower dimension al space to generate a latent feature [symbol] 118. In particular, the prior [symbol] ( [symbol] ᵢ, zᵢ|xᵢ) takes the octree xᵢ as input and computes the latent feature

$${ℓ}_{i} ∈ {ℝ}^{{N}_{i}^{′} \times {D}^{′}}$$

and code zᵢϵ [symbol] ^{D′} where

$${N}_{i}^{′}$$

and D′ are the number of points and the dimension of the latent feature. Internally, the latent code is sampled from the predicted mean and variance via reparameterization. The decoder [symbol] (yᵢ| [symbol] ᵢ, zᵢ, xᵢ) predicts a 3D reconstruction along with grasp poses. The save computational cost, the decoder 126 may predict occupancy at each depth, discarding grid cells with a probability below 0.5 Only in the final layer does the decoder predict the SDF, normal vectors, and grasp poses as well as occupancy. During training, KL divergence between the encoder and prior is minimized such that their distributions are matched. Referring back to FIG. 2, the prior octree encoder module 224 may implement the prior octree encoder module 224 may implement the prior encoder [symbol] 112 of FIG. 1, the posterior octree encoder module 226 may implement the posterior encoder [symbol] 124 of FIG. 1, and the decoder module 228 may implement the decoder [symbol] 126.

As discussed above, the prior encoder [symbol] 112 computes features per object. As such, it lacks the capability of modeling global spatial arrangements for collision-free reconstruction and grasp pose prediction. Accordingly, as shown in FIG. 1, the machine learning model 100 includes a multi-object encoder [symbol] 120. In particular, the multi-object encoder [symbol] 120 encodes multi-object reasoning to identify relationships between the objects in an image. In one example, the multi-object encoder [symbol] 120 comprises a transformer in the latent space, composed of K standard Transformer blocks with self-attention and Rotary Position Embedding (RoPE) positional encoding. The multi-object encoder [symbol] 120 takes voxel centers

$${r}_{i} ∈ {ℝ}^{{N}_{i}^{′} \times 3}$$

and its features

$${ℓ}_{i} ∈ {ℝ}^{{N}_{i}^{′} \times {D}^{′}}$$

of all the objects at the latent space are updated as

$$[ {ℓ}_{1} … {ℓ}_{L} ] ← ℳ ( [ {r}_{1} , {ℓ}_{1} ) … ( {r}_{L} , {ℓ}_{L} ) ] ) , \qquad ( 4 )$$

where L represents the total number of objects. Referring to FIG. 2, the multi-object encoder module 230 may implement the multi-object encoder [symbol] 120 of FIG. 1.

Referring back to FIG. 1, 3D occlusion fields [symbol] 122 may be used by the machine learning model 100 to account for occlusions between objects in images, as disclosed herein. The multi-object encoder [symbol] 120, discussed above, primarily learns to avoid collisions between objects and grasp poses in a cluttered scene, as collision modeling requires only local context, making it earlier to handle. In contrast, occlusion modeling requires a comprehensive understanding of the global context to accurately capture visibility relationships, since occluders and occludes can be positioned far apart. To mitigate this issue, the 3D occlusion fields [symbol] 122 may localize visibility information to voxels via simplified octree-based volume rendering.

In embodiments, the 3D occlusion field module 232 of FIG. 2 may be used to generate the 3D occlusion fields [symbol] 122 of FIG. 1. The 3D occlusion fields may encode inter- and self-occlusion information via simple ray casting. In particular, the 3D occlusion field module 232 may cast rays from a camera to the voxel centers around the target object and depth tests may be performed. This can be seen in FIG. 1, in which rays 308, 310, 312, and 314 are cast from a camera 301 onto the objects 302, 304. In particular, a voxel at the latent space made be subdivided into B³ smaller blocks (B blocks per axis), which are projected into the image space. In the example of FIG. 3, occlusion fields are determined for the object 302, for which the object 304 is an occluder. Occlusion fields may also be separately determined for the object 304.

If a ray intersects the target object, that is if a block lies within the instance mask corresponding to the target object, the 3D occlusion field module 232 may set a self-occlusion flag o_{self} to 1. This is shown by ray 310 in the example of FIG. 3, which intersects the object 302. If a ray intersects a non-target object, that is if a block lies within the instance mask of neighbor objects, the 3D occlusion field module 232 may set an inter-occlusion flag oᵢₙₜₑᵣ to 1. This is shown by ray 314 of FIG. 3, which intersects the object 304.

After computing the flags for all objects in an image, the 3D occlusion field module 232 may construct the 3D occlusion fields [symbol] ᵢϵ [symbol] ^{N′×B}^{³}^{×2} by concatenating the two flags of the i-th object. The 3D occlusion field module 232 may then encode the 3D occlusion fields by three layers of 3D convolutional neural networks (CNNs) that downsample the resolution by a factor of two at each layer to obtain an occlusion feature oᵢϵ [symbol] ^{N′×D″} at the latent space, and update the latent feature by [symbol] ᵢ←[ [symbol] ᵢ oᵢ] to account for occlusions as well as collisions.

Referring back to FIG. 2, the training module 234 may train the machine learning model 100, as disclosed herein. The training module 234 trains the parameters of the machine learning model 100 based to minimize a loss function between the predicted octree ŷ 130 output by the machine learning model 100 and the target octrees y 128 (the ground truth values). In particular, similar to standard variational autencoders (VAEs), the training module 234 trains the machine learning model 100 by maximizing the evidence lower bound (ELBO). Therefore, the loss function is defined as

$${ℒ}_{rec} = {ω}_{occ} {{\sum }_{h}}^{H} {ℒ}_{occ}^{h} + {ω}_{nrm} {ℒ}_{nrm} + {ω}_{SDF} {ℒ}_{SDF} , \qquad ( 5 )$$

$$ℒ = {ω}_{g} {ℒ}_{g} + {ω}_{q} {ℒ}_{q} + {ω}_{a} {ℒ}_{a} + {ω}_{t} {ℒ}_{t} + {ω}_{w} {ℒ}_{w} + {ω}_{d} {ℒ}_{d} , \qquad ( 6 )$$

$${ℒ}_{KL} = {ω}_{KL} {D}_{KL} ( ℰ ( {z}_{i} \vert {x}_{i} , {y}_{i} ) ‖ 𝒫 ( {ℓ}_{i} , {z}_{i} \vert {x}_{i} ) ) , \qquad ( 7 )$$

$$ℒ = {ℒ}_{rec} + {ℒ}_{grasp} + {ℒ}_{KL} , \qquad ( 8 )$$

where

$${ℒ}_{occ}^{h}$$

computes the mean of the binary cross entropy (BCE) function of occupancy at each depth h, and [symbol] ₙᵣₘ and [symbol] _{SDF} represent the averaged L2 distances of surface normal and SDF, respectively, at the final depth of the octree. [symbol] _{g}, [symbol] _{q}, [symbol] ₐ, [symbol] _{w} and [symbol] _{d} computes the averaged L2 distances of graspness, quality, an approach vector, width, and depth, respectively. Due to the symmetry of a gripper, the loss term of the tangential vector [symbol] ₜ computes the averaged sign-agnostic L2 distance as D_{SA}(a, b)=min(∥a−b∥₂, ∥a+b∥₂). Finally, the term [symbol] _{KL} measures the KL divergence between the posterior encoder [symbol] 124 and the prior encoder [symbol] 112. Each term ω is a weight parameter to align the scale of different loss terms.

During training, the training module 234 learns parameters for each of the posterior encoder [symbol] 124, a prior encoder [symbol] 112, the decoder [symbol] 126, and the multi-object encoder [symbol] 120. The learned parameters may be stored in the database 212. After the machine learning model 100 has been trained, the learned parameters may be used to predict grasp poses for objects in an unknown image, as discussed in further detail below.

Referring back to FIG. 2, the inference module 236 may be used to perform inference using the machine learning model 100 after it has been trained. In particular, an image of a scene containing one or more objects and a depth map associated with the image may be received by the image reception module 214. The inference module 236 may then input the image and the depth map into the trained machine learning model 100. During inference the posterior encoder [symbol] 124 may not be used, as this component is only used during training of the machine learning model 100. The decoder [symbol] 126 may output a predicted octree indicating grasps, normal, and an SDF for the objects in the image. As discussed above, the grasps may indicate how each of the objects in the scene may be grasped. Thus, a gripper (e.g., a robotic arm) may then utilize the predicted grasps to grasp and manipulate one or more objects in the scene.

This may allow a gripper to grasp objects in a scene. However, accurate contacts are desired for successful grasping, as they ensure stability and control during manipulation. While the machine learning model 100 predicts a width and depth of a gripper, even small errors may result in unstable grasping. Accordingly, in embodiments, the grasp pose refinement module 238 of FIG. 2 may refine the grasp poses predicted by the machine learning model 100, as disclosed herein.

FIG. 4 shows an example gripper 400 having left and right fingers C_{L} 402 and C_{R} 404. In embodiments, the grasp pose refinement module 238 may adjust the locations of fingertips of the gripper to align with the nearest contact points of left and right fingers C_{L} and C_{R} on the reconstruction. Based on the contact points, the width w is refined as

$$Δ w = min ( D ( {C}_{L} ) , D ( {C}_{R} ) ) , \qquad ( 9 )$$

$$w ← w + 2 ( max ( {γ}_{min} ( Δ w , {γ}_{max} ) ) - Δ w ) , \qquad ( 10 )$$

so that the contact distance Aw remains within the range γₘᵢₙ to γₘₐₓ. Note that D(c) denotes the contact distance from c. The grasp pose refinement module 238 may further adjust the depth d by

$$d ← max ( Z ( {C}_{L} ) , Z ( {C}_{R} ) ) , \qquad ( 11 )$$

where Z(c) computes depth of the contact point c. An example of this grasp pose refinement is shown in FIG. 4, in which initial grasp poses 406 is modified to final grasp pose 408. These refinement steps may help ensure stable grasps.

In addition, the grasp pose refinement module 238 may perform collision detection to identify predicted grasp poses that result in collisions with occluded regions. In particular, the grasp pose refinement module 238 may implement a model-free collision detector using a two-finger parallel gripper (e.g., the two-finger parallel gripper 400 of FIG. 4) based on the reconstructed shapes of the objects in the images. The grasp pose refinement module 238 may then discard predicted grasp poses that result in collision with occluded regions.

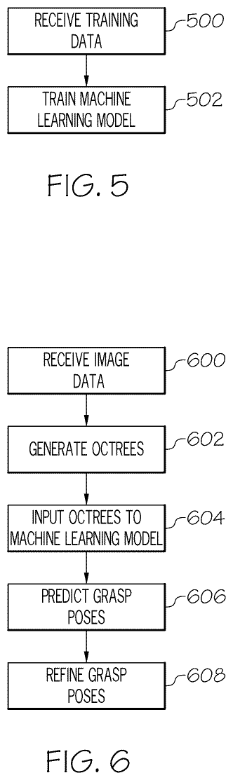

FIG. 5 depicts a flowchart of an example method for operating the computing device 200 to train the machine learning model 100, as disclosed herein. At step 500, the training data reception module 216 receives training data. As discussed above, the training data may comprise a plurality of images containing one or more objects, a plurality of depth maps associated with the plurality of images, and ground truth data comprising shapes and grasp poses associated with the one or more objects in the plurality of images. In particular, the ground truth data may comprise octree data comprising grasp poses for each object in the images, normal for each object in the images, and a SDF for each object in the images. At step 502, the training module 234 may train the machine learning model 100 based on the received training data, using the techniques discussed hereinabove. In particular, the training module 234 may train the machine learning model 100, using the training data, to receive a first image containing one or more first objects and a first depth map associated with the first image, and output first shapes of the one or more first objects and first grasp poses for the one or more first objects.

FIG. 6 depicts a flowchart of an example method for operating the computing device 200 after the machine learning model 100 has been trained. At step 600, the image reception module 214 receives a second image of a scene containing one or more second objects and a second depth map associated with the second image. At step 602, the octree conversion module 223 generates an octree based on the second image and the second depth map, as discussed hereinabove. At step 604, the inference module 236 inputs the octree into the trained machine learning model 100. At step 606, the inference module 236 predicts grasp poses for the one or more second objects in the scene based on an output of the trained machine learning model 100. At step 608, the grasp pose refinement module 238 refines the predicted grasp poses using the techniques described hereinabove. In some examples, the computing device 200 may cause a gripper to grasp and manipulate one or more of the objects based on the refined grasp poses.

It should now be understood that embodiments described herein are directed to a method and system for zero-shot shape reconstruction enabled robotic grasping. Using the techniques described herein, a machine learning model can be trained to accurately predict 3D reconstruction of objects and grasp poses for the objects based on a previously unseen image. Utilizing octrees as a shape representation enables efficient depth-first search, which is ideal for high-resolution shape reconstruction and dense grasp pose prediction in a memory and computationally efficient manner. The multi-object encoder models relations between objects via a 3D transformer in the latent space, thereby enabling collision-free 3D reconstructions and grasp poses. The 3D occlusion fields capture self- and inter-object occlusions to enhance shape reconstruction in occluded regions.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving training data comprising a plurality of images containing one or more objects, a plurality of depth maps associated with the plurality of images, and ground truth data associated with the plurality of images, the ground truth data comprising object shapes and grasp poses associated with the one or more objects in the plurality of images; and
training a machine learning model, using the training data, to receive a first image containing one or more first objects and a first depth map associated with the first image, and output first shapes of the one or more first objects and first grasp poses for the one or more first objects,
wherein the machine learning model comprises:
a conditional variational autoencoder;
a multi-object encoder to encode multi-object reasoning associated with an object; and
3D occlusion fields determined by ray casting.

2. The method of claim 1, further comprising:
determining image features associated with the plurality of images;
converting the image features to octrees; and
inputting the octrees to the machine learning model during the training of the machine learning model.

3. The method of claim 2, further comprising:
identifying the one or more objects in the plurality of images;
generating 2D instance masks for the one or more objects in the plurality of images; and
unprojecting the image features into 3D space based on the 2D instance masks and the instance masks.

4. The method of claim 2, wherein the conditional variational autoencoder comprises:
a first encoder to receive the ground truth data and output latent code;
a second encoder to receive the octrees as input, and output latent features; and
a decoder to predict a 3D reconstruction of the object shapes and the grasp poses.

5. The method of claim 1, wherein the multi-object encoder is configured to encode the multi-object reasoning to avoid collisions between the one or more objects in the plurality of images.

6. The method of claim 1, further comprising determining the 3D occlusion fields by:
casting rays from a camera to voxel centers around a target object among the one or more objects in the plurality of images;
setting a self-occlusion flag to 1 if a ray intersects the target object; and
setting an inter-object occlusion flag to 1 if a ray intersects a non-target object.

7. The method of claim 1, wherein the grasp poses comprise graspness, quality, approach vectors, tangential vectors, width, and depth.

8. The method of claim 1, further comprising:
inputting a second image containing one or more second objects and a second depth map associated with the second image into the trained machine learning model; and
determining second grasp poses associated with the one or more second objects based on an output of the trained machine learning model.

9. The method of claim 8, further comprising adjusting the grasp poses by adjusting fingertip locations of a gripper to align with near contact points on a reconstruction of the one or more second objects.

10. A computing device comprising one or more processors configured to:
receive training data comprising a plurality of images containing one or more objects, a plurality of depth maps associated with the plurality of images, and ground truth data associated with the plurality of images, the ground truth data comprising object shapes and grasp poses associated with the one or more objects in the plurality of images; and
train a machine learning model, using the training data, to receive a first image containing one or more first objects and a first depth map associated with the first image, and output first shapes of the one or more first objects and first grasp poses for the one or more first objects,
wherein the machine learning model comprises:
a conditional variational autoencoder;
a multi-object encoder to encode multi-object reasoning associated with an object; and
3D occlusion fields determined by ray casting.

11. The computing device of claim 10, wherein the one or more processors are further configured to:
determine image features associated with the plurality of images;
convert the image features to octrees; and
input the octrees to the machine learning model during the training of the machine learning model.

12. The computing device of claim 11, wherein the one or more processors are further configured to:
identify the one or more objects in the plurality of images;
generate 2D instance masks for the one or more objects in the plurality of images; and
unproject the image features into 3D space based on the 2D instance masks and the instance masks.

13. The computing device of claim 12, wherein the conditional variational autoencoder comprises:
a first encoder to receive the ground truth data and output latent code;
a second encoder to receive the octrees as input, and output latent features; and
a decoder to predict a 3D reconstruction of the object shapes and the grasp poses.

14. The computing device of claim 10, wherein the multi-object encoder is configured to encode the multi-object reasoning to avoid collisions between the one or more objects in the plurality of images.

15. The computing device of claim 10, wherein the one or more processors are further configured to determine the 3D occlusion fields by:
casting rays from a camera to voxel centers around a target object among the one or more objects in the plurality of images;
setting a self-occlusion flag to 1 if a ray intersects the target object; and
setting an inter-object occlusion flag to 1 if a ray intersects a non-target object.

16. The computing device of claim 10, wherein the grasp poses comprise graspness, quality, approach vectors, tangential vectors, width, and depth.

17. The computing device of claim 10, wherein the one or more processors are further configured to:
input a second image containing one or more second objects and a second depth map associated with the second image into the trained machine learning model; and
determine second grasp poses associated with the one or more second objects based on an output of the trained machine learning model.

18. The computing device of claim 17, wherein the one or more processors are further configured to adjust the grasp poses by adjusting fingertip locations of a gripper to align with near contact points on a reconstruction of the one or more second objects.

19. A non-transitory computer readable storage medium comprising a memory storing a program that, when executed by a processor, causes the processor to:
receive training data comprising a plurality of images containing one or more objects, a plurality of depth maps associated with the plurality of images, and ground truth data associated with the plurality of images, the ground truth data comprising object shapes and grasp poses associated with the one or more objects in the plurality of images; and
train a machine learning model, using the training data, to receive a first image containing one or more first objects and a first depth map associated with the first image, and output first shapes of the one or more first objects and grasp poses for the one or more first objects,
wherein the machine learning model comprises:
a conditional variational autoencoder;
a multi-object encoder to encode multi-object reasoning associated with an object; and
3D occlusion fields determined by ray casting.

20. The non-transitory computer readable storage medium of claim 19, wherein the program further causes the processor to:
input a second image containing one or more second objects and a second depth map associate with the second image into the trained machine learning model; and
determine second grasp poses associated with the one or more second objects based on an output of the trained machine learning model.
